(19) United States
(12) Patent Application Publication
(10) Pub. No.: US 2005/0058474 A1
(43) Pub. Date: Mar. 17, 2005

(54) Cleaning device, process cartridge, and image forming apparatus

(76) Inventors: Kazuhiko Watanabe, Tokyo (JP); Daichi Yamaguchi, Tokyo (JP); Kenji Sugiura, Tokyo (JP); Yasushi Nakazato, Tokyo (JP); Masahiko Shakuto, Tokyo (JP); Osamu Naruse, Tokyo (JP); Hidetoshi Yano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/942,902

(22) Filed: Sep. 17, 2004

(30) Foreign Application Priority Data
Sep. 17, 2003 (JP) 2003-325310
Feb. 27, 2004 (JP) 2004-055526

(51) Int. Cl. G03G 21/00

(52) U.S. Cl. 399/353; 399/358

(57) ABSTRACT

In a cleaning device cleans off toners from a surface of an image carrier and a collection roller. The toners have a roundness of 0.96 degrees to 1.00 degrees. The cleaning device includes a brush roller that cleans toners from the image carrier, the collection roller that cleans toners from the brush roller, and a cleaning unit that cleans toner from the collection roller. The cleaning unit includes a blade that abuts a surface of the collection roller; a vibrating unit that vibrates the blade; and an oscillating unit that oscillates the vibrating unit. The cleaning unit cleans off toners by a vibration of a portion of the blade in which portion the blade member contacts with the collection roller.

### CROSS-REFERENCE TO RELATED APPLICATIONS

The present document incorporates by reference the entire contents of Japanese priority document, 2003-325310 filed in Japan on Sep. 17, 2003 and 2004-055526 filed in Japan n Feb. 27, 2004.

### BACKGROUND OF THE INVENTION

1) Field of the Invention

The present invention relates to a technology for cleaning unwanted toners remaining on a surface of an image carrier.

2) Description of the Related Art

An image forming apparatus of a so-called electrophotographic type requires a cleaning unit that removes residual toners remaining on a surface of an image carrier after a transfer step so as to use the image carrier repeatedly for image formation. The cleaning unit that is widely used is a cleaning blade made of an elastic material such as rubber. This cleaning unit is simple in configuration and has excellent performance.

Japanese Patent Application Laid-Open No. H11-212420 (hereinafter, “Patent Literature 1”) discloses a cleaning device that included a cleaning roller rotated when being contacted with a photoconductor, a collection roller rotated when being contacted with the cleaning roller, and a blade contacted with a periphery of the collection roller, wherein irregular portions are provided on a surface of the collection roller.

Another approach disclosed in the Patent literature 1 is to provide a means that vibrates the collection roller or the blade. For example, an actuator may be connected to the collection roller or the blade so as to directly vibrate the collection roller or the blade. A vibration groove may be provided at a bearing of the collection roller so as to vibrate the collection roller.

The Patent Literature 1 discloses the use of vibrations for removing the toners from the collection roller. However, the Patent Literature 1 fails to explicitly explain the details such as vibration conditions, a mechanism of an effect produced by the vibrations, vibration method, and specific embodiments of a configuration. In addition, the Patent Literature 1 fails to explain whether spherical toners can be removed by the vibrations.

According to claims 9 and 10 in the Patent Literature 1, it is specified that a pumping unit is “irregularities on the surface”. The Patent Literature 1 fails to explain why the toner removal performance is improved by vibrating the blade. The specification does not explain in detail the embodiments or explanations by the drawings. It is difficult or impossible to vibrate the blade having a thickness of 2.0 millimeters using the actuator. Even if it is possible, the vibration unit and the vibration method are not explained.

Japanese Patent Application Laid-Open No. 2001-013837 (hereinafter, “Patent Literature 2”) discloses a cleaning device that includes an image carrier; a transfer unit that transfers the toner image from the image carrier to a recording medium; a moving mechanism that moves the image carrier; and a cleaning blade that removes unwanted toners from the surface of the image carrier after the toner image is transferred onto the recording medium, and that is abutted on the image carrier.

According to the Patent Literature 2, in a region where the cleaning blade is abutted on the image carrier, a cleaning auxiliary agent having a mean volume particle diameter of 0.1 micrometer to 3 micrometers smaller than a toner particle diameter is caused to stay by a width of 50 micrometers to 100 micrometers upstream of a moving direction of the image carrier.

Therefore, even if a gap is arises between the cleaning blade and the image carrier due to a minute vibration, it is possible to prevent the transfer residual toners from passing through the gap. As a result, toners can be cleaned satisfactorily.

Japanese Patent Application Laid-Open No. 2001-066963 (hereinafter, “Patent Literature 3”) discloses a cleaning device for cleaning unwanted toners from the surface of an electrophotographic photoconductor. The cleaning device is an elastic rubber blade.

According to the Patent Literature 3, the photoconductor includes a structure unit that can transport electric charge, and a resin layer containing a cycloxan-based resin and a bridge structure. The rubber blade is abutted on the photoconductor in a counter direction, and it is vibrated under conditions of a vibration magnitude of 10 micrometers to 200 micrometers. The residual toners on the photoconductor are thereby cleaned off. The blade vibrates due to friction with the photoconductor.

Japanese Patent Application Laid-Open No. 2003-043871 (hereinafter, “Patent Literature 4”) discloses a cleaning device that includes an elastic blade member abutted on a photosensitive drum; a motor unit that oscillates using an operation controllable motor having a sector weight attached to an output axis; a control circuit that controls the motor; and a frame that holds the blade member and the motor unit, a vibration of the frame or the blade member during an oscillating operation of the motor unit is greater than that during image formation.

The Patent Literature 4 thus relates to cleaning of the photoconductor. An experiment conducted by the inventors of the present invention showed that, because the photoconductor disclosed in the Patent Literature 4 is cylindrical and 20 micrometers to 50 micrometers in thickness, the vibrations of the blade are transmitted even to the photoconductor, and this results in a considerable reduction in a toner removal effect.

However, if the toners are pulverized ones, the toners can be removed by abutting a toner removing member on a cleaning roller in a counter direction without vibrating the photoconductor.

When the cleaning roller is rotated, a tip end of the cleaning blade member turns into a state in which a tip end face is turned up by a frictional force of a friction between the cleaning blade member and the cleaning roller. A wedge is formed between the tip end of the cleaning blade member thus turned up and the cleaning roller.

FIG. 19 is a schematic diagram of a relationship between the tip end of the cleaning blade member and the cleaning roller. It is assumed that the toners are pulverized toners. The pulverized toners are caught in a wedge nip and cleaned off.

FIG. 20 is a schematic diagram of a relationship between the tip end of the cleaning blade member and the cleaning roller. It is assumed that the toners are spherical toners. The spherical toners rotate so that they are difficult to clean. Therefore, as against the pulverized toners shown in FIG. 19, the spherical toners are not caught in the wedge nip and are difficult to clean.

More specifically, normally, an adhesive force is high and a friction coefficient of the image carrier is high in a contact portion in which the toners and the cleaning rollers contact each other. This contact portion is, therefore, higher in friction coefficient than a contact portion between the toners and the cleaning blade member.

As a result, the spherical toners caught in the wedge between the cleaning blade member and the image carrier are given a moment of rotating the contact portion with the cleaning roller as a drive source, and pass through the wedge while being rotated, as shown in FIG. 20. This results in incomplete cleaning.

Thus, in case of the spherical toners, it is very difficult to clean off the toners using the cleaning blade. Therefore, a brush to clean the toners becomes necessary. However, the toners accumulate within the bristles of the brush so that the toners can not be cleaned properly with such a brush. Thus, a means to clean off the toners accumulated within the bristles of the brush becomes necessary. Such a means is a cleaning roller that can electrostatically attract the toners within the bristles of the brush to the cleaning roller. However, unless the toners moved to the cleaning roller are promptly removed, the same problem occurs again. As a result, the cleaning property of the cleaning device for cleaning the image carrier eventually deteriorates.

Secondly, if the spherical toners are used, it is very difficult to clean off the toners from the cleaning roller using the cleaning blade member. Cleaning using the cleaning roller is, therefore, effective. Similarly to the first disadvantage, this, in turn, causes a problem of the need to remove the spherical toners from the cleaning roller using the cleaning blade member.

If the spherical toners are used in the cleaning device constituted to remove residual toners and foreign objects other than the toners from the cleaning roller using the cleaning blade member, it is known that incomplete cleaning occurs when a normal blade cleaning method is used.

Nevertheless, the cleaning blade member is indispensable so as to scrape off foreign objects such as discharge products which are generated when, for example, paper powder on the image carrier or the image carrier is energized by discharge.

Considering the disadvantage, the cleaning device is constituted to electrostatically remove the spherical toners using the cleaning roller, and to remove small amounts of toners and the foreign objects which cannot be removed by the cleaning roller using the cleaning blade member.

A disadvantage of this constitution is that it is necessary to consider how to remove the toners, which have been electrostatically removed from the image carrier by the cleaning roller, and which stay on the cleaning roller.

If the toners on the cleaning roller are not removed, a surface resistance of the cleaning roller is increased. If so, the toners on the image carrier cannot be electrostatically attached onto the cleaning roller. A toner adhesive quantity exceeds that can be scraped off by the cleaning blade member, thereby resulting in incomplete cleaning. This disadvantage occurs when the spherical toners are used as toners.

### SUMMARY OF THE INVENTION

It is an object of the present invention to solve at least the problems in the conventional technology.

A cleaning device according to an aspect of the present invention includes an image carrier; a brush roller that cleans off residual toners on a surface of the image carrier, wherein the toners have a roundness of 0.96 to 1.00 according to a flow particle image analyzer; a collection roller that collects the toners moved to the brush roller; and a cleaning unit. The cleaning unit includes a blade member that abuts a surface of the collection roller; a vibrating unit that is attached to the blade member and that vibrates the blade member; and an oscillating unit that is attached to the vibrating member and that oscillates the vibrating member. The cleaning unit removes toners on the collection roller by a vibration of a portion of the blade member in which portion the blade member contacts with the collection roller.

A cleaning device according to another aspect of the present invention includes a cleaning roller provided downstream of a cleaning blade relative to a rotation direction of an image carrier; and a toner removing member that removes toners attached to the cleaning roller. The toner removing member includes a blade member that abuts a surface of the collection roller; a vibrating unit that is attached to the blade member and that vibrates the blade member; and an oscillating unit that is attached to the vibrating member and that oscillates the vibrating member. Toners on the cleaning roller are removed by a vibration of a portion of the blade member in which portion the blade member contacts with the cleaning roller.

A process cartridge according to still another aspect of the present invention includes the above cleaning device.

An image forming apparatus according to still another aspect of the present invention includes the above process cartridge.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram for explaining a cleaning mechanism according to the present invention;

FIG. 2 is an enlarged schematic diagram of a portion shown with a dotted circle in FIG. 1;

FIG. 3 is a bar graph which depicts a result of vibration of a surface of an image carrier near a toner removing member and vibration of a contact portion of the toner removing member;

FIG. 4 is a bar graph which depicts a result of measuring the vibration of the toner removing member and that of a surface of a roller member near the contact portion of the toner removing member;

FIG. 5 is a schematic diagram of a cleaning device according to an embodiment of the present invention;

FIG. 6 is a schematic diagram of a cleaning device according to another embodiment of the present invention;

FIG. 7 is an enlarged view of a toner removing member shown in FIG. 6;

FIG. 8 is another enlarged view of a toner removing member shown in FIG. 6;

FIG. 9 is a schematic diagram of an oscillating unit that is attached in a width direction of a cleaning roller;

FIG. 10 is a schematic diagram of a drive circuit that applies a common drive signal to piezoelectric elements of the oscillating unit;

FIG. 11 is a schematic diagram of a state in which a blade member is abutted on a cleaning roller;

FIG. 12 is a schematic diagram for explaining a definition of roundness;

FIG. 13 is a schematic diagram of an image forming apparatus that includes the cleaning device according to an embodiment of the present invention;

FIG. 14 is a schematic cross-section of a process cartridge that includes the cleaning device according to the present invention;

FIG. 15 is a schematic diagram of a color image forming apparatus that uses the process cartridge shown in FIG. 14;

FIG. 16 is a schematic diagram of an image forming apparatus that includes the cleaning device according to another embodiment of the present invention;

FIG. 17 is a schematic cross-sectional block diagram of a process cartridge according to the present invention;

FIG. 18 is a schematic diagram for explaining a color image forming apparatus that uses the process cartridge shown in FIG. 17;

FIG. 19 is a schematic diagram of a relationship between the tip end of a cleaning blade member and the cleaning roller in a mechanism of cleaning pulverized toners by a conventional cleaning blade if the pulverized toners are used; and

FIG. 20 is a schematic diagram of a relationship between the tip end of the cleaning blade member and the cleaning roller for a mechanism in which, if spherical toners are used, the spherical toners are rotated to cause incomplete cleaning.

### DETAILED DESCRIPTION

Exemplary embodiments of a cleaning device, a process cartridge, and an image forming apparatus according to the present invention will be explained in detail with reference to the accompanying drawings. As explained above, spherical toners are difficult to clean with a cleaning blade, and it is effective to vibrate a toner removing member to clean the image carrier.

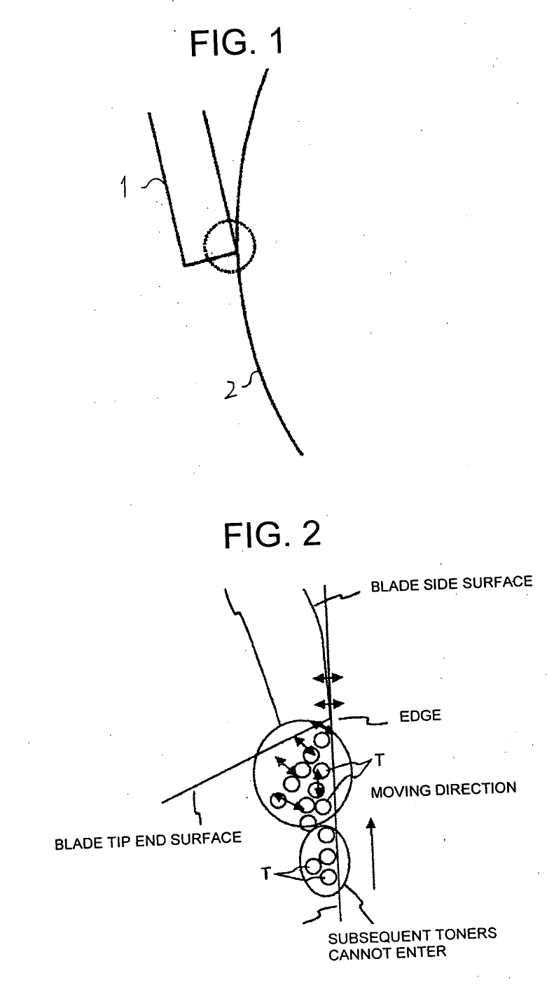

FIG. 1 is a schematic diagram for explaining a cleaning mechanism according to the present invention. FIG. 2 is an enlarged schematic diagram of a portion shown with a dotted circle in FIG. 1.

A cleaning device according to the present invention applies vibrations with a toner removing member (a cleaning blade) 1 to toners T in a wedge portion formed by the toner removing member 1 and a cleaning roller (a roller member) 2. The cleaning device thereby prevents rotation of the toners T that occurs due to a frictional force, and effectively cleans the spherical toners T. The toner removing member is, for example, a rubber blade.

These vibration operations can prevent the spherical toners T from entering into a nip of the toner removing member 1 by vibrating the blade nip so that the blade nip has a different shape and a different motion from a conventional cleaning blade. The vibration operations help completely clean the spherical toners T.

Namely, FIG. 2 depicts a state in which the toner removing member 1 is vibrated, the vibrations are transmitted to the spherical toners T, and in which the spherical toners T are actively vibrated. FIG. 2 depicts a result of an observation by a high-speed video camera through a high-power microscope.

The observation result shows that the spherical toners near a tip end cut surface of the toner removing member 1 including the rubber blade and the cleaning roller 2 are vibrated over a range corresponding to several toners.

In this state, the vibrated toners near the nip function as a barrier (a vibration toner wall), thereby preventing entry of subsequent toners on the cleaning roller 2. Thus, even the spherical toners with truly spherical particles can be completely cleaned.

The observation also shows that it is necessary to transmit the vibration from the toner removing member 1 only to the toners.

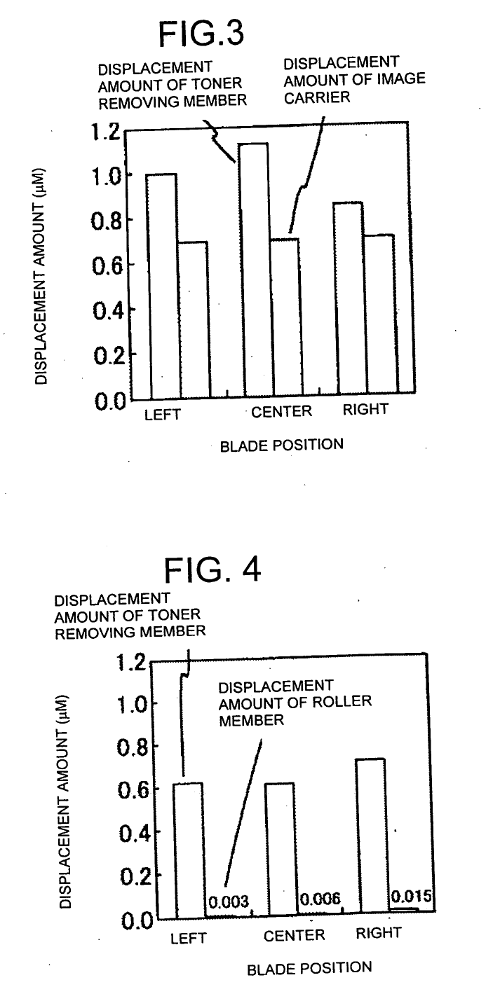

FIG. 3 is a bar graph which depicts a result of the vibration of a surface of an image carrier near the toner removing member 1 and the vibration of a contact portion of the toner removing member 1. Specifically, FIG. 3 depicts a result of measuring the vibration of the toner removing member 1 and that of the surface of the image carrier near the contact portion of the toner removing member when the toner removing member 1 is abutted on the image carrier to apply a vibration to the image carrier and thereby clean off the spherical toners.

As shown in FIG. 3, the toner carrier (image carrier) is vibrated substantially at the same level as that of the toner removing member 1. The reason is as follows. If a very thin member such as the image carrier is used, then the vibration of the toner removing member 1 is directly propagated to the toner carrier, and the toners cannot be vibrated. If so, it is known that a cleaning property of the cleaning device tends to be deteriorated.

FIG. 4 is a bar graph which depicts a result of measuring the vibration of the toner removing member 1 and that of a surface of the roller member 2 near the contact portion of the toner removing member 1. Specifically, FIG. 4 depicts a result of measuring the vibration of the toner removing member 1 and that of the surface of the roller member 1 near the contact portion of the toner removing member 1 when the toner removing member 1 is abutted on the roller member 2 consisting of an elastic body to apply a vibration to the roller member 2 and thereby clean off the spherical toners.

As shown in FIG. 4, while the toner removing member 1 is vibrated, the roller member 2 is hardly vibrated for the following reason. By using a material that absorbs the vibration such as the elastic body, the vibration of the toner removing member 1 is not propagated to the toner carrier. Therefore, only the toners in contact with the toner removing member 1 can be vibrated, thereby considerably improving the cleaning property of the cleaning device.

The observation result also shows the following respects. If the toner removing member 1 is vibrated, then a frictional force of a friction between the toner removing member 1 and the roller member 2 is reduced, and a condition for eliminating a phenomenon that the cut surface of the blade member 1 is turned up as seen in the conventional cleaning device, is established.

The phenomenon that “the cut surface is turned up” means herein a phenomenon that the cut surface is deformed following movement of the roller member 2 and the cut surface contacts with the surface of the roller member as shown in FIG. 19.

By eliminating occurrence of the turning-up of the cut surface of the blade member 1, a stress applied to the toner removing member 1 from the roller member 2 is reduced, and a remarkable effect that a durability of the toner removing member 1 and that of the roller member 2 are eventually, considerably improved can be obtained. As can be seen, since the spherical toners T moved to the roller member 2 can be completely removed, a toner removing property for removing the toners from a cleaning brush is improved. In addition, incomplete cleaning of the image carrier can be prevented, and the toners moved from the image carrier to the roller member 2 can be completely removed.

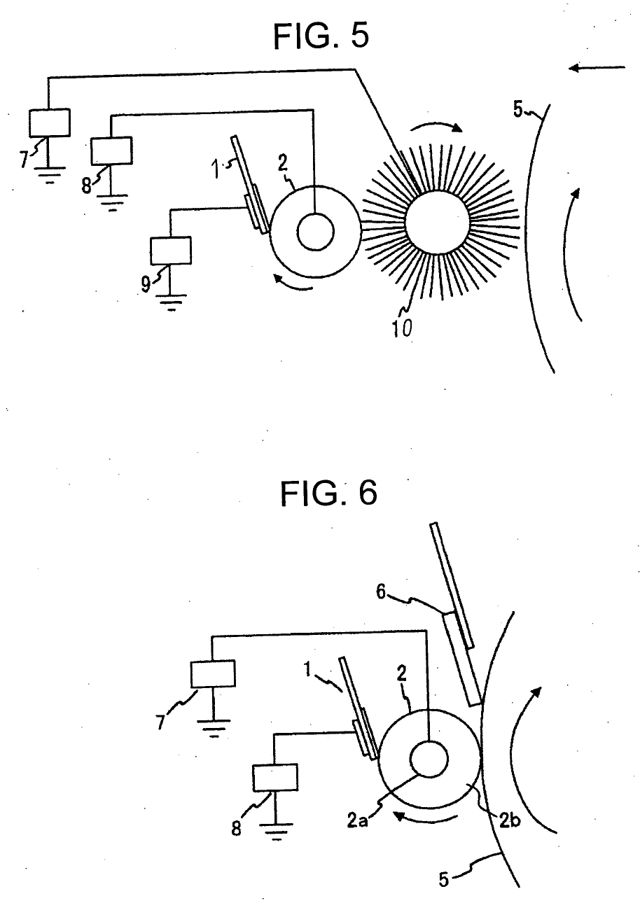

FIG. 5 is a schematic diagram of a cleaning device according to an embodiment of the present invention. A cleaning brush 10 is arranged so as to clean off the toners remaining on an image carrier 5. The cleaning brush 10 is arranged so as to form the nip having a predetermined width between the cleaning brush 10 and the image carrier 5. The image carrier 5 and the cleaning brush 10 are rotated in the opposite directions.

The cleaning brush 10 is a roll brush obtained by spirally winding a tape which has a conductive fiber as a pile material, around a metal core that also serves as an electrode. As the conductive fiber, a material having a conductive material such as carbon added to a fiber consisting of polyester, nylon, or acryl fiber is used.

Examples of the fiber are not limited to the polyester fiber, the nylon fiber, and the acryl fiber as long as the fiber is a conductive fiber. By applying a predetermined voltage to the core of the cleaning brush 10 from a power supply 7, the residual toners on the image carrier 5 is cleaned off.

The cleaning roller 2 is provided so as to be in contact with the cleaning brush 10. The cleaning roller 2 is arranged so as to form a nip having the predetermined width between the cleaning brush 10 and the cleaning roller 2. The cleaning roller 2 is rotated in the same direction as the rotation direction of the image carrier 5 and the cleaning brush 10.

The cleaning roller 2 includes an elastic and conductive layer obtained by dispersing conductive fine particles consisting of an oxide of a metal such as carbon black, titanium, or aluminum, an ion conducting agent into an elastic material such as polyurethane rubber, silicon rubber, or butadiene rubber around the core.

Alternatively, a metal member such as special use stainless steel (SUS) may be used as a core and the core may be directly used as the cleaning roller 2. A cleaning bias is applied to the core of the cleaning brush 10 from the power supply 8, thereby electrostatically attracting the toners accumulated within bristles of the cleaning brush 10.

The voltage applied to the cleaning brush 10 is a voltage different in polarity from the residual toners on the image carrier 5. In addition, a voltage equal in polarity to the voltage applied to the cleaning brush 10 but higher in absolute value than the voltage applied to the cleaning brush 10 is applied to the cleaning roller 10 so as to move the toners from the cleaning brush 10 to the cleaning roller 2.

For example, if the residual toners on the image carrier 5 have a negative polarity, then a voltage of 100 volts and a voltage of 300 volts are applied to the cleaning brush 10 and the cleaning roller 2, respectively. If so, the residual toners on the image carrier 5 can be cleaned off.

The residual toners which have remained on the image carrier 5 and then moved to the cleaning brush 10 are taken first by the cleaning brush 10 by rotation sliding of the cleaning brush 10 and a function of an electric field. The toners thus taken are introduced to the cleaning roller 2 following rotation of the cleaning brush 10, and moved onto the cleaning roller 2 by the voltage applied to the cleaning roller 2.

The toners collected onto the cleaning roller 2 are scraped off by the toner removing member 1 arranged to be in contact with the cleaning roller 2.

FIG. 6 is a schematic diagram of a cleaning device according another embodiment of to the present invention. A cleaning blade 6 and the cleaning roller 2 are arranged to clean off the residual toners on the image carrier 5.

The cleaning roller 2 is arranged to form the nip having the predetermined width between the cleaning roller 2 and the image carrier 5. The image carrier 5 and the cleaning roller 2 are rotated in the same direction.

The cleaning roller 2 includes an elastic conductive layer 2b which is obtained by dispersing conductive fine particles consisting of an oxide of a metal such as carbon black, titanium, or aluminum, an ion conducting agent into an elastic material such as polyurethane rubber, silicon rubber, or butadiene rubber around a core 2a, and which is stacked in the form of a roller.

A cleaning bias is applied to the core 2a of the cleaning roller 2 from the power supply 7 so as to electrostatically attract the toners on the image carrier 5. The voltage different in polarity from the residual toners on the image carrier 5 is applied to the cleaning roller 2.

For example, if the residual toners on the image carrier 5 have a negative polarity, then a voltage of 100 volts to 600 volts is applied to the cleaning roller 2. If so, the residual toners on the image carrier 5 can be cleaned off. The toners collected on the cleaning roller 2 are scrapped off by the cleaning blade 1 arranged to be in contact with the cleaning roller 2.

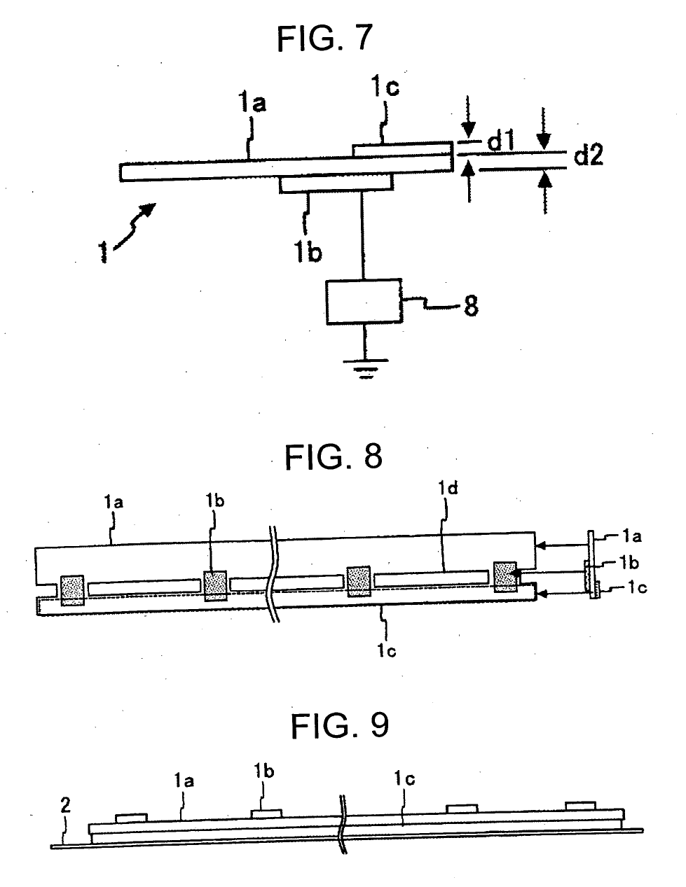

FIG. 7 is a schematic diagram of the configuration of the cleaning blade 1. The cleaning blade 1 includes a vibrating member 1a, an oscillating unit 1b, and a blade member 1c. A pressing force of the blade member 1c against the cleaning roller 2 is applied from the vibrating member 1a, thereby vibrating the blade member 1c and removing the toners from the cleaning roller 2.

The blade member 1c is arranged on an opposite surface of the vibrating member 1a to a surface thereof to which the oscillating unit 1b is attached so as to transmit the vibration from the oscillating unit 1b through the vibrating member 1a to the blade member 1c.

The blade member 1c is an elastic body consisting of polyurethane rubber and has a thickness d1 of 50 micrometers to 2000 micrometers, preferably 100 micrometers to 500 micrometers.

If the thickness of the blade member 1c is too small, a sufficient bite of the blade member 1c into the cleaning roller 2 cannot be secured. If the thickness is too large, the blade member 1c absorb the vibration from the vibrating member 1a, resulting in deterioration of the toner removing property of the cleaning device. If a hard member having a JISA hardness of 85 degrees to 100 degrees is used as a material for the blade member 1c, vibration transmission efficiency can be improved.

It is also preferable that the blade member 1c, or at least a surface thereof, is formed by a material having a low compatibility to the toners to be used. By so forming, it is possible to prevent the toners from being attached and fixed onto the surface of the blade member 1c, and prevent degradation in cleaning with the passage of time.

Conversely, if a material low in compatibility to the surface of the blade member 1c is used as an external additive added to exteriors of the toner, it is possible to prevent the toner external additive from being attached and fixed onto the surface of the blade member 1c.

By doing so, it is possible to lessen occurrence of incomplete cleaning with the passage of time. In addition, if a wax necessary for fixing is added to the exteriors of the toners, occurrence of filming resulting from the wax can be lessened.

It suffices that the oscillating unit 1b can efficiently vibrate the vibrating member 1a, and either one oscillating unit 1b or a plurality of oscillating units 1b may be provided. The oscillating unit 1b is arranged on a cleaning roller 2-side tip end of the vibrating member 1a.

The oscillating unit 1b oscillates the vibrating member 1a, and a piezoelectric element serving as an electromechanical transducer, particularly a plate (single plate) piezoelectric element is used as the oscillating unit 1b. By using the plate piezoelectric element, the oscillating unit 1b which can easily obtain a displacement amount at a low cost, and which can electrically change a vibration amount of the blade member 1c can be constituted.

This oscillating unit 1b is attached on a support member side of the vibrating member 1a and on the opposite surface of the vibrating member 1a to the surface thereof onto which he blade member 1c is attached. The attachment position of the oscillating unit 1b is not limited to a specific position.

The single plate piezoelectric element that constitutes the oscillating unit 1b includes an electrode consisting of printed-fired silver (Ag) or the like on each of both surfaces of a piezoelectric layer consisting of lead zirconate titanate or the like, i.e., each of the surface of the oscillating unit 1b on which the oscillating unit 1b is connected with the vibrating member 1a and an opposite surface thereof.

By applying a voltage of 100 volts to 300 volts to the piezoelectric element polarized by the electrodes and having a thickness of 0.3 millimeter to 0.5 millimeter, a shrinkage deformation in a plate direction occurs to the piezoelectric element. As a result, a deformation vibration that bends the vibrating member 1a can be applied to the vibrating member 1a.

This bending vibration is high in deformation efficiency when the piezoelectric element (oscillating unit 1b) and the vibrating member 1a are substantially equal in rigidity. Therefore, a resin vibration transmitting member having a thickness of, for example, 0.2 millimeter to 0.4 millimeter or 0.3 millimeter to 1.0 millimeter is preferably used as the vibrating member 1a.

The vibrating member 1a has a structure which can produces a vibration and a support structure. The vibrating member 1a is made of a material having higher rigidity than the elastic blade member 1c. Therefore, the vibrating member 1a is made of a metal member such as a soft steel plate or an SUS plate, or a resin formed member into which carbon and glass fiber are mixed.

This vibrating member 1a has one end fixed to a fixed portion and the other end serving as a free end, and the free end of the vibrating member 1a is attached to the blade member 1c. The fixed portion is fixed to a housing of the cleaning device.

The thickness d1 of the blade member 1c is 50 micrometers to 2000 micrometers, preferably 100 micrometers to 500 micrometers. The vibrating member 1a functions as a holder of the blade member 1c so as to determine an abutment angle and a bite of the blade member 1c with respect to the cleaning roller 2.

With this configuration, a vibration propagation efficiency can be improved while using the thin elastic blade member 1c, and the nip which can deal with a-warping of the blade member 1c and a waviness on the surface of the cleaning roller can be stably formed, and the good cleaning property can be ensured.

FIG. 8 is a top view of the cleaning blade 1. FIG. 8 also depicts cross-sectional views of the respective constituent elements of the cleaning blade 1. A broken line indicates the blade member 1b which is arranged on a rear surface portion of FIG. 8. FIG. 9 is a schematic diagram of a configuration in which the oscillating unit 1c is attached in a width direction of the cleaning roller 2.

A oscillating unit 1b is arranged at each of a plurality of predetermined positions along a longitudinal direction of the vibrating member 1a. The oscillating units 1b are constituted so that, by setting the rigidity of the tip end of the vibrating member 1a to be higher than that of the blade member 1c, the tip end of the vibrating member 1a can be vibrated more efficiently. The oscillating units 1b are provided near the cleaning roller 2-side tip end of the vibrating member 1a, that is, on the opposite surface to the surface of the vibrating member 1a to which the blade member 1c is attached.

Depending on the configuration of the vibrating member 1a, the oscillating units 1b may be attached anywhere between the fixed end of the vibrating member 1a and the blade tip end (free end) thereof as long as the oscillating units 1b can oscillate the vibrating member 1a. The attachment positions of the oscillating units 1b are not limited to specific positions. In addition, a gap 1d is provided in the vibrating member 1a between the oscillating units 1b and the vibrating member 1a so as to improve the vibration efficiency.

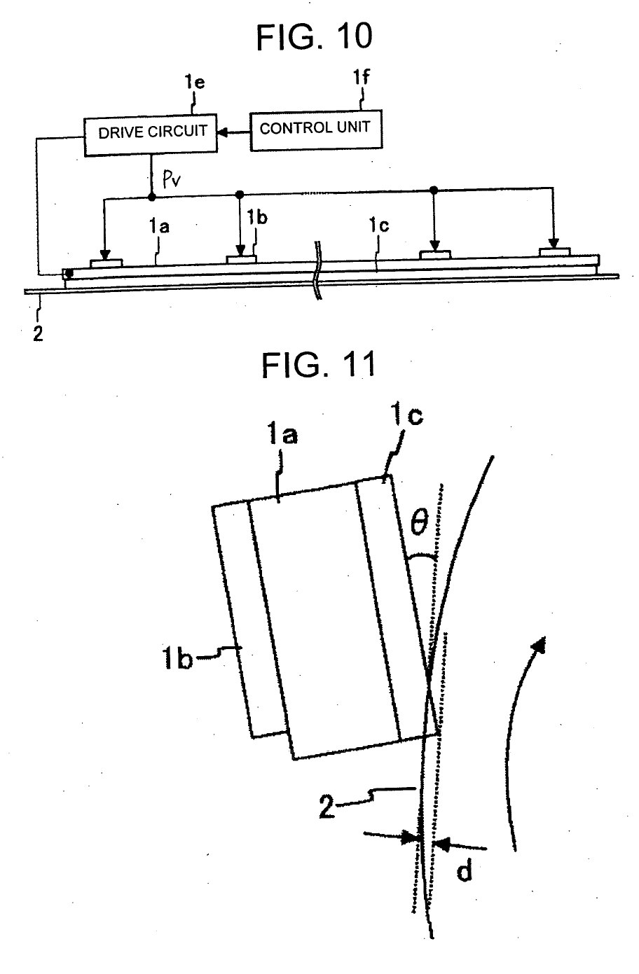

FIG. 10 is a schematic diagram of a drive circuit that applies a common drive signal to the piezoelectric elements that constitute the respective oscillating units 1b. As shown in FIG. 10, the cleaning device according to the present invention includes a drive circuit 1e that applies a common drive signal Pv to the piezoelectric elements constitute the respective oscillating units 1b of the cleaning device.

By driving the blade member 1c using the common drive circuit 1e when a plurality of oscillating units 1b are provided in the width direction of the blade member 1c, a uniformity of the vibration in the width direction of the blade member 1c can be enhanced.

The drive circuit 1e, which is controlled by a main control unit 1f of an image forming apparatus, applies the drive signal Pv to the respective oscillating units 1b at a predetermined timing. According to the present invention, the cleaning device is constituted so as to clean the entire width of the cleaning roller 2 using one oscillating blade (blade member 1c).

Alternatively, the cleaning device may be arranged to clean the entire width of the cleaning roller 2 using a plurality of oscillating blades (blade members 1c). If so, each of the oscillating units 1b of a plurality of cleaning devices can be driven by a common drive circuit.

A metal member (a conductive member) is used as the vibrating member 1a. Electrodes of the piezoelectric elements that constitute the respective oscillating units 1b are directly contacted with and electrically connected with the vibrating member 1a, thereby connecting the electrodes of the oscillating units 1b to one another through the vibrating member 1a.

With such a structure, the drive signal can be applied with a simple circuit configuration. The direct contact of the electrodes with the vibrating member 1a can be easily made by finishing a connected surface of each electrode into a roughened surface, and connecting the electrode with the vibrating member 1a by a thin bonding layer. Alternatively, each electrode may be connected with the vibrating member 1a using a conductive adhesive.

In the cleaning device thus constituted, if the drive signal Pv at a required frequency is applied from the drive circuit 1e to the oscillating units 1b to thereby cause a bending deformation to the piezoelectric elements that constitute the respective oscillating units 1b, the vibrating member 1a vibrates and the vibration of this vibrating member 1a causes the vibration of the blade member 1c.

It is preferable that the toner removing member 1 further includes a unit that electrically controls the displacement amount of the blade member 1c. In addition, each oscillating unit 1b is preferably a piezoelectric element. If the oscillating unit 1b is the piezoelectric element, the toner removing member 1 preferably includes a unit that applies an alternate voltage to the piezoelectric elements.

If the voltage Vpp applied to the oscillating units 1b is 20 volts to 40 volts and the required frequency is 20 kilohertz to 40 kilohertz, the most excellent cleaning property can be attained. In addition, since the frequency is out of the audible frequency range, no sound of noise is heard.

FIG. 11 is an enlarged side view of a state in which the blade member 1c abuts the cleaning roller 2. The blade member 1c abuts the cleaning roller 2 in a leading (counter) direction relative to a rotation direction of the cleaning roller 2. The blade member 1c bites into the surface of the cleaning roller 2 by a width d. In addition, the blade member 1c abuts the cleaning roller 2 at an appropriate angle θ.

The toners that have been cleaned off from the cleaning roller 2 by the toner removing member 1 are transmitted by a toner transport member (not shown) and accumulated in a waste toner bottle (not shown) as waste toners. The waste toner bottle is collected by a service person or the like. On the other hand, the toners can be transported to a developing unit as recycle toners to be used for development.

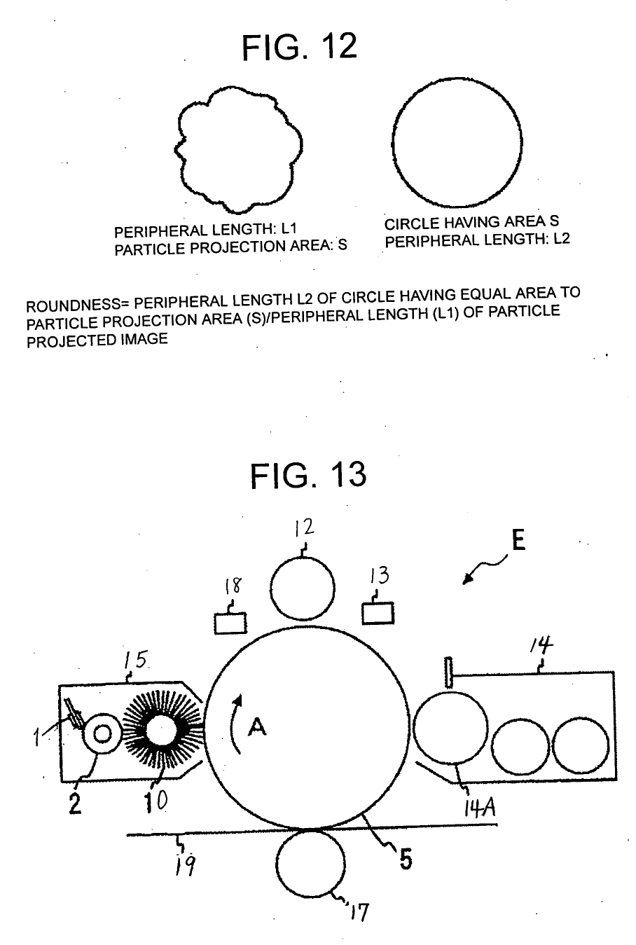

FIG. 12 is a schematic diagram for explaining a definition of roundness of toners. To form a high-quality image by an image forming apparatus using spherical toners, it is important that the toners have a specific shape.

Namely, if the toners have a mean roundness of less than 0.95 and have unfixed shapes so different from a sphere, a high-quality image free from transfer and expulsion cannot be obtained. It is, therefore, preferable that the toner roundness is equal to or higher than 0.95.

To measure the shape of the toners, it is appropriate to use a measuring method based on an optical detection area, including steps of causing a suspension containing particles to pass through a flat imaging unit detection area, and optically detecting and analyzing a particle image by a charge coupled device (CCD) camera.

The mean roundness is obtained by dividing a peripheral length of an equivalent circle equal in projection area obtained by this measuring method by a peripheral length of an existing particle. It is discovered that the use of the toners having the mean roundness of 0.95 or more is effective for forming an image having an appropriate density, an appropriate reproducibility, and a high fineness. The mean roundness of the toners is preferably 0.960 to 0.998.

This value can be measured as the mean roundness using a flow particle image analyzer FPIA-200 (a product name, manufactured by Sysmex Corporation). A specific measuring method is as follows. A surface active agent, preferably alykylbenzene sulfonate, of 0.1 milliliter to 0.5 milliliter is added as a dispersing agent, as well as a measurement sample of 0.1 gram to 0.5 gram into water of 100 milliliter to 150 milliliter, from which impurity solid maters are removed, in a container.

The suspension into which the sample is dispersed is subjected to a dispersion treatment for about 1 to 3 minutes by an ultrasonic disperser to have a dispersion liquid density of 3000 to 1 (10,000/μl). A toner shape and a toner distribution are measured by the FPIA-200 using the resultant suspension, thereby measuring the toner roundness.

FIG. 13 is a schematic diagram of an image forming apparatus that includes the cleaning device shown in FIG. 5. The image forming apparatus E includes the image carrier 5 that rotates in a direction shown by an arrow A. The image forming apparatus E includes a charging unit 12, an exposure unit 13, a developing unit 14, a cleaning device 15, a transfer unit 17, and a charge eliminating unit 18. These units are arranged around the image carrier 5.

Further, a fixing apparatus (not shown) which fixes a toner image on a transfer material 19 transferred from the image carrier 5 is arranged. The charging unit 12 is arranged on a surface of the image carrier 5 in contact with or non-contact of the image carrier 5 at a predetermined distance.

By applying a bias to the charging unit 12, the image carrier 5 is charged to have a predetermined polarity and a predetermined potential. The exposure unit 13, which employs a laser diode (LD) or a light emitting diode (LED) as a light emitting element, irradiates a light onto the image carrier 5 based on image data and thereby forms an electrostatic latent image.

The developing unit 14 includes a developer carrier 14A which is rotatable with a magnet roller that is fixed inside, and holds a developer onto the developer carrier 14A. The image forming apparatus E performs two-component magnetic brush development using a two-component developer consisting of a toner and a carrier. Alternatively, the image forming apparatus E may perform mono-component development without using a carrier.

A voltage is applied to the developer carrier 14A from a development bias power supply. Using a potential difference between this development bias and the electrostatic latent image formed on the surface of the image carrier 5, the charged toners are attached to the electrostatic latent image in a development region, and development is then performed.

The transfer unit 17 contacts with the surface of the image carrier 5 at a predetermined pressing force during transfer, and a voltage is applied to the transfer unit 17. The transfer unit 17 thereby transfers the toner image on the image carrier 5 onto the transfer material 19 in a transfer nip between the image carrier 5 and the transfer unit 17. While the image forming apparatus E performs transfer using the transfer roller, a transfer unit such as a corotron or a transfer belt may be used in place of the transfer roller.

The cleaning device 15 is the cleaning device according to the present invention. The residual toners on the image carrier 5 moved to a region of the cleaning brush 10 are taken first by the cleaning brush 10 by rotation sliding of the cleaning brush 10 and a function of an electric field.

The toners thus taken are introduced to the cleaning roller 2 following rotation of the cleaning brush 10, and moved onto the cleaning roller 2 by the voltage applied to the cleaning roller 2.

The toners collected onto the cleaning roller 2 are scraped off by the toner removing member 1 arranged to be in contact with the cleaning roller 2.

The toner removing member 1 includes the blade member 1c, the vibrating member 1a, and the oscillating unit 1b. As explained, a required vibration is applied to the blade member 1c, thereby removing the residual toners on the surface of the cleaning roller 2.

The toners thus cleaned off from the image carrier 5 by this cleaning device 15 are transmitted by the toner transport member (not shown) accumulated in the waste toner bottle (not shown) as waste toners, collected by the service person or the like, or transported to the developing unit 14 as recycle toners to be used for development.

The charge eliminating unit 18 eliminates residual charges of the image carrier 5 from which the residual toners are removed by the cleaning device 15. As the charge eliminating unit 18, a charge eliminating apparatus of an optical charge elimination type using a light emitting diode (LED) or the like is employed.

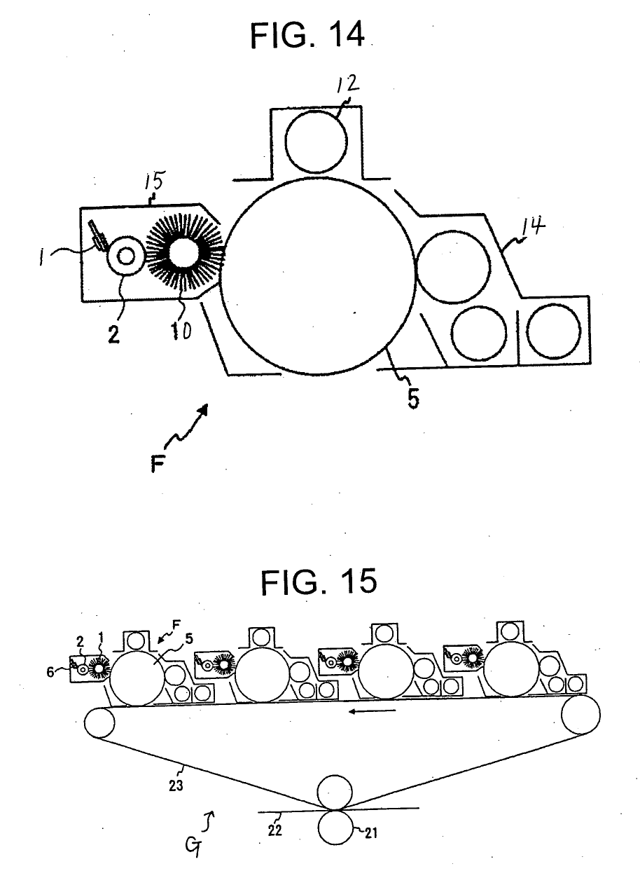

FIG. 14 is a schematic cross-sectional block diagram of a process cartridge that includes the cleaning device shown in FIG. 5. This process cartridge F is constituted so that at least one of a charging unit, a developing unit, and a cleaning unit is formed integrally with an electrophotographic photoconductor, and which is detachable to an image forming apparatus unit.

Namely, this process cartridge F is constituted so that a plurality of constituent elements among the image carrier 5, the charging unit 12, the developing unit 14, the cleaning device 15 according to the present invention, and the like are formed integrally as the process cartridge F. The process cartridge F is provided detachably to the image forming apparatus unit such as a copier or a printer.

By including the cleaning device 15 in the detachable process cartridge F, it is possible to improve maintainability and facilitate integral replacement with another cartridge.

Furthermore, if a fault occurs due to one of the constituent elements or apparatuses explained above in detail, the process cartridge F can be restored to its original state at an early time only by replacement with another process cartridge. Therefore, a service time can be reduced. In addition, the improved cleaning property for cleaning the electrophotographic photoconductor greatly contributes to a longer life of the process cartridge F.

FIG. 15 is a schematic diagram of a color image forming apparatus that uses the process cartridge shown in FIG. 14.

This image forming apparatus G is a tandem color image forming apparatus constituted so that a plurality of process cartridges F corresponding to respective colors are arranged in parallel along a transfer belt (an image carrier) 23. Four process cartridges F are arranged to correspond to yellow, magenta, cyan, and black, respectively. The developed toners on the image carrier developed by the respective process cartridges F are sequentially transferred to the transfer belt 23 extending horizontally and applied with a transfer voltage.

Images of yellow, magenta, cyan, and black are thus formed. The images are subsequently transferred onto the transfer belt 23 in a multiple manner, and then the transfer unit 17 transfers the images on the transfer material 19 all at once.

The multiple toner images on the transfer material 19 are fixed by the fixing apparatus (not shown). While the process cartridges F are explained in an order of yellow, magenta, cyan, and black, the order of the cartridges F is not limited to this order or may be set arbitrarily.

Normally, the color image forming apparatus G is large in size since it includes a plurality of image forming units. Further, when a fault occurs to a individual unit such as the cleaning device or charging unit or a replacement time for replacing the individual unit comes due to the end of its life, it takes much labor and time to replace the unit to another one due to its complicated configuration.

Considering the disadvantage, the present invention provides a color image forming apparatus that enables a user to replace a constituent unit with another one, which is downsized, and which ensures a longer durability by constituting the constituent elements such as the image carrier, the charging unit, and the developing unit to be combined integrally as the process cartridge.

The blade member consists of the elastic member and is caused to bite into the cleaning roller 2 by a constant amount. Due to this, if the blade member is too thick, the blade member absorbs the vibration. By restricting the thickness of the blade member to be small, therefore, the blade member can be efficiently vibrated. Accordingly, the removing property of the cleaning roller 2 is improved.

By thus vibrating the portion in which the toner removing member 1 contacts with the cleaning roller 2, it is possible to weaken an adhesive force of the toners on the cleaning roller 2. It is, therefore, possible to completely remove the residual toners on the cleaning roller 2 using the toner removing member 1.

As a result, the toners accumulated in the bristles of the cleaning brush can be efficiently collected to the cleaning roller 2, and the toner removing property of the cleaning brush is improved. It is thereby possible to ensure cleaning the residual toners on the image carrier 5.

By constituting the constituent elements such as the image carrier, the charging unit, the developing unit, and the cleaning device according to the present invention to be integrally combined with one another as the process cartridge, it is possible to provide the color image forming apparatus that enables replacement by users, which is downsized, and which has a higher durability.

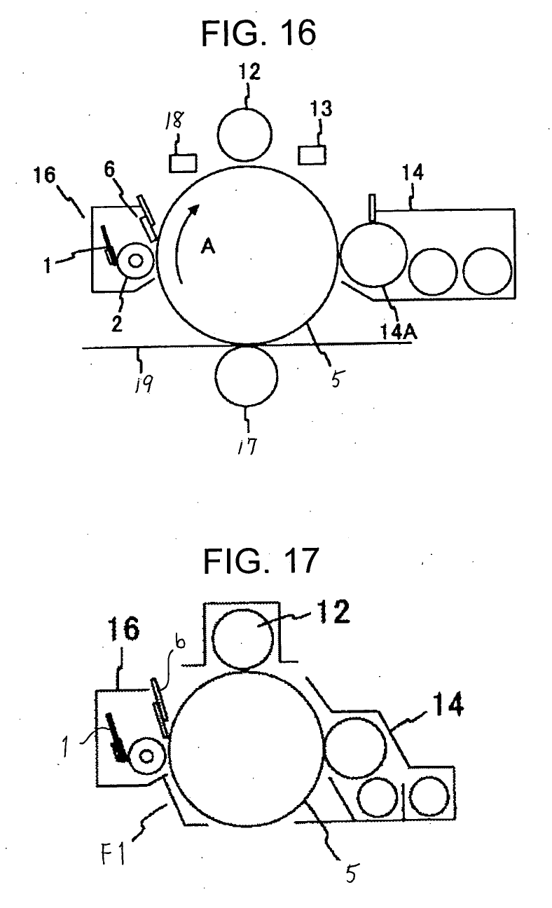

FIG. 16 is a schematic diagram of an image forming apparatus that includes the cleaning device shown in FIG. 6. This image forming apparatus includes the image carrier 5 rotated in the arrow A direction. In addition, the image forming apparatus includes the charging unit 12, the exposure unit 13, the developing unit 14, a cleaning device 16, the transfer unit 17, and the charge eliminating unit 18 which are arranged around the image carrier 5.

Further, the fixing apparatus (not shown) which fixes a toner image on the transfer material 19 transferred from the image carrier 5 is arranged. The charging unit 12 is arranged on the surface of the image carrier 5 in contact with or non-contact of the image carrier 5 at a predetermined distance. By applying a bias to the charging unit 12, the image carrier 5 is charged to have a predetermined polarity and a predetermined potential.

The exposure unit 13, which employs an LD or an LED as a light emitting element, irradiates a light onto the image carrier 5 based on image data and thereby forms an electrostatic latent image. The developing unit 14 includes a magnet roller fixed inside and the developer carrier 14A which is rotatably arranged on an outside diameter side of the magnet roller. The developing unit 14 holds a developer onto the developer carrier 14A.

This image forming apparatus performs two-component magnetic brush development using a two-component developer consisting of a toner and a carrier. Alternatively, the image forming apparatus may perform mono-component development without using a carrier.

A voltage is applied to the developer carrier 14A from a development bias power supply. Using a potential difference between this development bias and the electrostatic latent image formed on the surface of the image carrier 5, the charged toners are attached to the electrostatic latent image in a development region, and development is then performed.

The transfer unit 17 contacts with the surface of the image carrier 5 at a predetermined pressing force during transfer, and a voltage is applied to the transfer unit 17. The transfer unit 17 thereby transfers the toner image on the image carrier 5 onto the transfer material 19 in the transfer nip between the image carrier 5 and the transfer unit 17.

While this image forming apparatus performs transfer using the transfer roller, a transfer unit such as a corotron or a transfer belt may be used in place of the transfer roller. The cleaning device 16 is the cleaning device according to the present invention. The cleaning device 16 cleans off spherical toners using the cleaning blade 6 and the cleaning roller 2.

The toners collected on onto the cleaning roller 2 in the cleaning device 16 are scraped off by the toner removing member 1 arranged to be in contact with the cleaning roller 2.

As already explained, to measure the shape of the toners, it is appropriate to use the measurement method for optically detecting and analyzing a particle image by a CCD camera is appropriate.

The mean roundness is obtained by dividing a peripheral length of an equivalent circle equal in projection area obtained by this measuring method by a peripheral length of an existing particle. It is discovered that the use of the toners having the mean roundness of 0.95 or more is effective for forming an image having an appropriate density, an appropriate reproducibility, and a high fineness. The definition of the roundness is shown in FIG. 12.

With reference to FIG. 12, if the peripheral length is L1, the particle projection area is S, and the peripheral length of a circle having an area S is L2, the roundness is represented by (the peripheral length L2 of the circle having an equal area to the particle projection area S)/(the peripheral length L1 of a particle projected image).

The toner removing member 1 includes the blade member 1c, the vibrating member 1a, and the oscillating unit 1b. As explained, a required vibration is applied to the blade member 1c, thereby removing the residual toners on the surface of the cleaning roller 2.

The toners thus cleaned off from the image carrier 5 by the cleaning device 16 are transmitted by the toner transport member (not shown) accumulated in the waste toner bottle (not shown) as waste toners, collected by the service person or the like, or transported to the developing unit 14 as recycle toners to be used for development.

The charge eliminating unit 18 eliminates residual charges of the image carrier 5 from which the residual toners are removed by the cleaning device 16. As the charge eliminating unit 18, a charge eliminating apparatus of an optical charge elimination type using an LED or the like is employed.

FIG. 17 is a schematic cross-sectional block diagram of a process cartridge that uses the cleaning device shown in FIG. 6. This process cartridge is defined as an apparatus that is constituted so that at least one of the charging unit, the developing unit, and the cleaning unit is formed integrally with an electrophotographic photoconductor, and which is detachable to an image forming apparatus unit.

The process cartridge including the cleaning device according to the present invention will be explained with reference to FIG. 17. This process cartridge F1 is constituted so that a plurality of constituent elements among the image carrier 5, the charging unit 12, the developing unit 14, the cleaning device 15 according to the present invention, and the like are formed integrally as the process cartridge F1.

The process cartridge F1 is provided detachably to the image forming apparatus unit such as a copier or a printer. By including the cleaning device 16 in the detachable process cartridge F1, it is possible to improve maintainability and facilitate integral replacement with another cartridge.

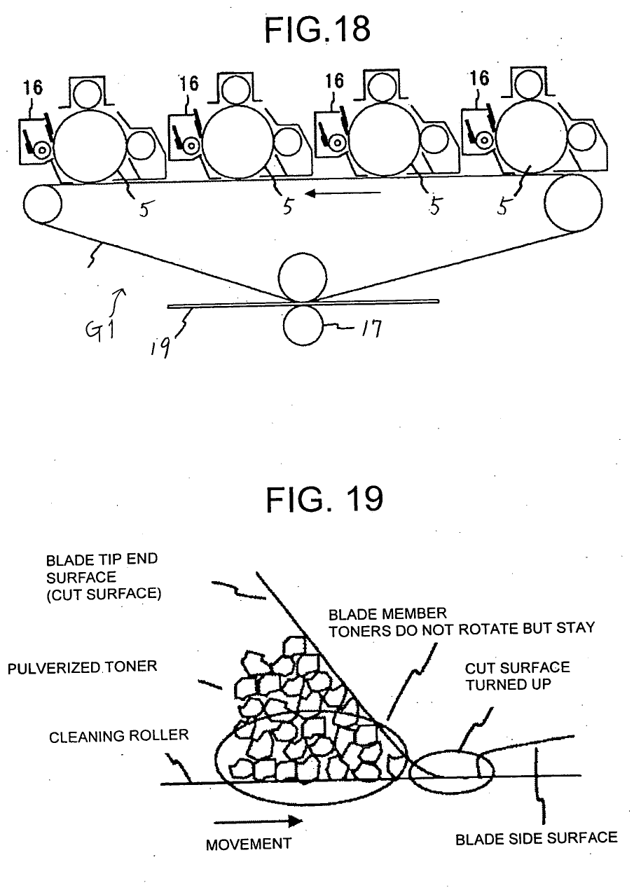

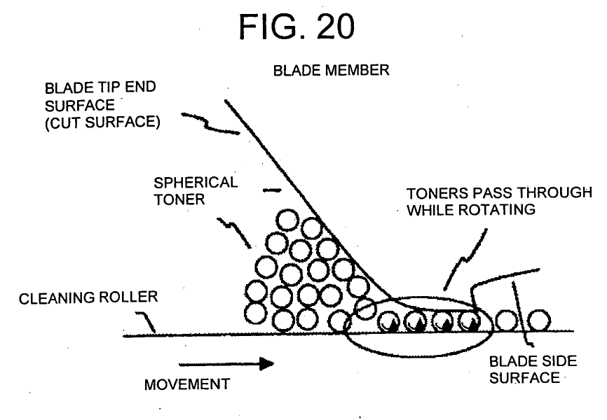

FIG. 18 is a schematic diagram for explaining a color image forming apparatus that uses the process cartridge shown in FIG. 17. This image forming apparatus G1 is a tandem color image forming apparatus constituted so that a plurality of process cartridges corresponding to respective colors are arranged in parallel along the transfer belt (an image carrier) 23.

Four process cartridges are arranged to correspond to yellow, magenta, cyan, and black, respectively. The developed toners on the image carrier 5 developed by the respective process cartridges are sequentially transferred to the transfer belt 23 extending horizontally and applied with a transfer voltage.

In this way, images of yellow, magenta, cyan, and blacks are formed. The multiple images are transferred onto the transfer belt 23, and transferred collectively onto the transfer material 19 by the transfer unit 17.

The multiple toner images on the transfer material 19 are fixed by the fixing apparatus (not shown). While the process cartridges are explained in an order of yellow, magenta, cyan, and black, the order of the cartridges is not limited to this order or may be set arbitrarily.

Normally, the color image forming apparatus is large in size since it includes a plurality of image forming units. Further, when a fault occurs to a individual unit such as the cleaning device or the charging unit or a replacement time for replacing the individual unit comes due to the end of its life, it takes much labor and time to replace the unit to another one due to its complicated configuration.

Considering the disadvantage, the present invention can provide a color image forming apparatus that enables a user to replace a constituent unit, which is downsized, and which ensures longer durability by constituting the constituent elements such as the image carrier 5, the charging unit 12, and the developing unit 14 to be combined integrally as the process cartridge.

If a very thin member such as the image carrier 5 is used, then the vibration from the vibrating member 1a is also propagated to the image carrier 5, the cleaning property of the cleaning device is often deteriorated.

Considering the disadvantage, an elastic body is used as the roller member (cleaning roller) 2 and the vibration from the vibrating member 1a is absorbed by the elastic body so that the vibration is transmitted only to the toners. By doing so, the toner removing property for removing the toners from the cleaning roller 2 can be improved.

The blade member 1c consists of the elastic member and is caused to bite into the cleaning roller 2 by a constant amount. Due to this, if the blade member 1c is too thick, the blade member absorbs the vibration. By restricting the thickness of the blade member 1c to be small, therefore, the blade member 1c can be efficiently vibrated. Accordingly, the removing property of the cleaning roller 2 is improved.

The blade member 1c consists of the elastic member and is caused to bite into the cleaning roller 2 by a constant amount. Due to this, if the blade member 1c is low in rigidity, the blade member 1c absorbs the vibration. By restricting the rigidity to be low, therefore, the blade member 1c can be efficiently vibrated. Accordingly, the removing property of the cleaning roller 2 is improved.

At least the surface of the blade member 1c is formed by a material having a low compatibility to the toners. By so forming, it is possible to prevent the toners from being attached and fixed onto the surface of the blade member 1c, and thereby prevent deterioration in the removing property for removing the toners from the cleaning roller 2 with the passage of time.

By providing a control unit that electrically controls the displacement amount of the blade member 1c to electrically produce the vibration, a vibration amount can be easily controlled even when a fluctuation in environment, a fluctuation with the passage of time, or the like occurs.

By employing the plate piezoelectric element as the oscillating unit 1b, the displacement amount can be easily obtained at a low cost, and the vibration amount of the blade member 1c can be electrically changed. In addition, by connecting the electrodes of a plurality of oscillating units 1b to one another through the vibrating unit 1a, the drive signal can be applied with a simple circuit configuration.

By using the cleaning device according to the present invention for an image forming apparatus, spherical toners can be fully utilized. Therefore, the image forming apparatus with a good image quality and an improved cleaning margin can be attained.

By constituting the constituent elements such as the image carrier 5, the charging unit 12, the developing unit 14, and the cleaning device 16 according to the present invention to be combined integrally into the process cartridge F1, a good image quality can be obtained, a cleaning margin can be improved, and the user can replace the process cartridge F1 to another process cartridge.

By constituting the constituent elements such as the image carrier 5, the charging unit 12, the developing unit 14, and the cleaning device 16 according to the present invention to be combined integrally into the process cartridge, it is possible to provide a color image forming apparatus with an improved image quality and an improved cleaning margin, which enables the user to replace the process cartridge to another process cartridge, which is downsized, and which ensures a higher durability.

According to the present invention, by vibrating the blade member in contact with the roller member as the toner removing unit that removes the toners from the roller member (cleaning roller), the adhesive force of the toner onto the roller member can be reduced, and the toner removing property of the blade member can be improved.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A cleaning device, comprising:
an image carrier;
a brush roller that cleans off residual toners on a surface of the image carrier, wherein the toners have a roundness of 0.96 to 1.00 according to a flow particle image analyzer;
a collection roller that collects the toners moved to the brush roller; and
a cleaning unit that includes
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.

2. The cleaning device according to claim 1, wherein
the blade member is an elastic body, and a thickness of the blade member is between 50 micrometers to 2000 micrometers, and preferably between 100 micrometers to 500 micrometers.

3. The cleaning device according to claim 1, wherein
the blade member is made of a material having JISA hardness of 85 degrees to 100 degrees.

4. The cleaning device according to claim 1, wherein
at least a surface of the blade member including an abutment portion with the collection roller is formed by a material having a low compatibility to the toners.

5. The cleaning device according to claim 1, further comprising:
a displacement amount control unit that electrically controls a displacement amount of the blade member.

6. The cleaning device according to claim 1, wherein
the oscillating unit is a plate piezoelectric element.

7. The cleaning device according to claim 6, wherein the oscillating unit includes a plurality of plate piezoelectric elements, and
electrodes of the piezoelectric elements are directly contacted with and electrically connected with the vibrating member consisting of a conductive material.

8. An image forming apparatus comprising:
a cleaning device including
an image carrier;
a brush roller that cleans off residual toners on a surface of the image carrier, wherein the toners have a roundness of 0.96 to 1.00 according to a flow particle image analyzer;
a collection roller that collects the toners moved to the brush roller; and
a cleaning unit that includes
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller, wherein
the cleaning device cleans off the toners remaining on the surface of the image carrier after a latent image is formed on the surface of the image carrier, the latent image is developed using the toners to form a toner image, and the toner image is transferred onto a transfer material.

9. A process cartridge comprising:
at least one of an image carrier, a charging unit, a developing unit, and a transfer unit; and
a cleaning device comprising:
a brush roller that cleans off residual toners on a surface of the t least one of the image carrier, the charging unit, the developing unit, nd the transfer unit, wherein the toners have a roundness of 0.96 to 1.00 according to a flow particle image analyzer;
a collection roller that collects the toners moved to the brush roller; and
a cleaning unit that that includes
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.

10 An image forming apparatus that forms a color image, comprising a plurality of process cartridges each having at least one of an image carrier, a charging unit, a developing unit, and a transfer unit; and
a cleaning device that includes
a brush roller that cleans off residual toners on a surface of the at least one of the image carrier, the charging unit, the developing unit, and the transfer unit, wherein the toners have a roundness of 0.96 to 1.00 according to a flow particle image analyzer;
a collection roller that collects the toners moved to the brush roller; and
a cleaning unit that includes
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.

11. A cleaning device comprising:
a cleaning roller provided downstream of a cleaning blade relative to a rotation direction of an image carrier; and
a toner removing member that removes toners attached to the cleaning roller, the toner removing member including
a blade member that abuts a surface of the collection roller;
a vibrating unit that is attached to the blade member and that vibrates the blade member; and
an oscillating unit that is attached to the vibrating member and that oscillates the vibrating member, and
toners on the cleaning roller are removed by a vibration of a portion of the blade member in which portion the blade member contacts with the cleaning roller.

12. The cleaning device according to claim 11, wherein
the cleaning roller consists of an elastic body.

13. The cleaning device according to claim 11, wherein
the blade member is an elastic body, and a thickness of the blade member is between 50 micrometers to 2000 micrometers.

14. The cleaning device according to claim 11, wherein
the blade member is made of a material having JISA hardness of 85 degrees to 100 degrees.

15. The cleaning device according to claim 11, wherein
at least a surface of the blade member including an abutment portion with the collection roller is formed by a material having a low compatibility to the toners.

16. The cleaning device according to claim 11, further comprising:
a control unit that electrically controls a displacement amount of the blade member.

17. The cleaning device according to claim 11, wherein
the oscillating unit is a plate piezoelectric element.

18. The cleaning device according to claim 17, wherein the oscillating unit includes a plurality of plate piezoelectric elements, and
electrodes of the piezoelectric elements are directly contacted with and electrically connected with the vibrating member consisting of a conductive material.

19. A process cartridge comprising:
at least one of an image carrier, a charging unit, a developing unit, and a transfer unit;
a cleaning roller provided downstream of a cleaning blade relative to a rotation direction of the image carrier; and
a cleaning device that includes
a toner removing member that removes toners attached to the cleaning roller;
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.

20. An image forming apparatus comprising a process cartridge, the process cartridge having
at least one of an image carrier, a charging unit, a developing unit, and a transfer unit;
a cleaning roller provided downstream of a cleaning blade relative to a rotation direction of the image carrier; and
a cleaning device that includes
a toner removing member that removes toners attached to the cleaning roller;
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.

21. An image forming apparatus comprising:
a cleaning roller provided downstream of a cleaning blade relative to a rotation direction of an image carrier; and
a toner removing member that removes toners attached to the cleaning roller, the toner removing member including
a blade member that abuts a surface of the collection roller;
a vibrating unit that is attached to the blade member and that vibrates the blade member; and
an oscillating unit that is attached to the vibrating member and that oscillates the vibrating member, and
toners on the cleaning roller are removed by a vibration of a portion of the blade member in which portion the blade member contacts with the cleaning roller, wherein
the cleaning device cleans off the toners remaining on the surface of the image carrier after a latent image is formed on the surface of the image carrier, the latent image is developed using the toners to form a toner image, and the toner image is transferred onto a transfer material.

22. An image forming apparatus that forms a color image, comprising a plurality of process cartridges each having at least one of an image carrier, a charging unit, a developing unit, and a transfer unit;
a cleaning roller provided downstream of a cleaning blade relative to a rotation direction of the image carrier; and
a cleaning device that includes
a toner removing member that removes toners attached to the cleaning roller;
a blade member that abuts a surface of the collection roller;
a vibrating unit that is attached to the blade member and that vibrates the blade member; and
an oscillating unit that is attached to the vibrating member and that oscillates the vibrating member, and
the cleaning unit removes toners on the collection roller by a vibration of a portion of the blade member in which portion the blade member contacts with the collection roller.
